(19) United States
(12) Patent Application Publication
(10) Pub. No.: US 2018/0184089 A1
(43) Pub. Date: Jun. 28, 2018

(54) TARGET BIT ALLOCATION FOR VIDEO CODING

(71) Applicant: Intel Corporation, Santa Clara, CA (US)

(72) Inventors: Ximin Zhang, San Jose, CA (US); Sang-Hee Lee, Santa Clara, CA (US)

(73) Assignee: Intel Corporation, Santa Clara, CA (US)

(21) Appl. No.: 15/392,449

(22) Filed: Dec. 28, 2016

(51) Int. Cl. H04N 19/126; H04N 19/31; H04N 19/15

(52) U.S. Cl. CPC H04N 19/126; H04N 19/184; H04N 19/15; H04N 19/31

(57) ABSTRACT

A system, method, and apparatus for video encoding with a target bit allocation is described herein. The method comprises obtaining an initial bit allocation ratio, estimating a temporal correlation, and adjusting the initial bit allocation ratio based on the temporal correlation. The method also comprises calculating a target frame size based on the adjusted bit allocation ratio and the temporal correlation and generating transform coefficients to achieve a quantization parameter based on the target frame size.

### BACKGROUND ART

A video encoder compresses video information so that a larger amount of information can be sent over a given bandwidth. The compressed signal may then be transmitted to a receiver that decodes or decompresses the signal prior to display. Bit rate control is often used to control the number of generated bits for various video applications. A video application may provide a target bit rate and buffer constraint to a rate control module. The rate control module may use this information to control the encoding process such that target bit rate is met and any buffer constraints are not violated.

### BRIEF DESCRIPTION OF THE DRAWINGS

FIG. 1 is a block diagram of an exemplary system that enables target bit allocation for video coding;

FIG. 2 is a block diagram of target bit allocation according to the present techniques;

FIG. 3A is an illustration of a typical encoding structure when the GOP size equals four;

FIG. 3B is an illustration of a typical encoding structure when the GOP size equals eight;

FIG. 3C is an illustration of a typical encoding structure when the GOP size equals four;

FIG. 3D is an illustration of a typical encoding structure when the GOP size equals four;

FIG. 4 is a process flow diagram of quantization parameter (QP) derivation;

FIG. 5 is a process flow diagram of a method for target bit allocation for video coding; and

FIG. 6 is a block diagram showing a tangible, non-transitory computer-readable medium that stores code for target bit allocation.

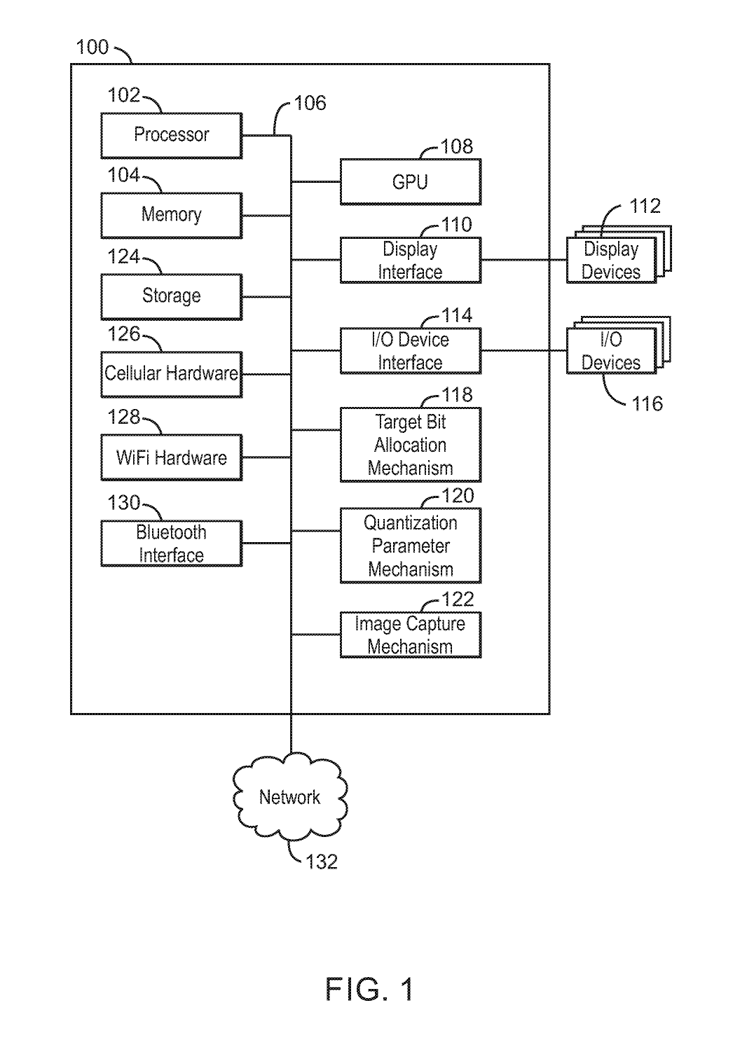

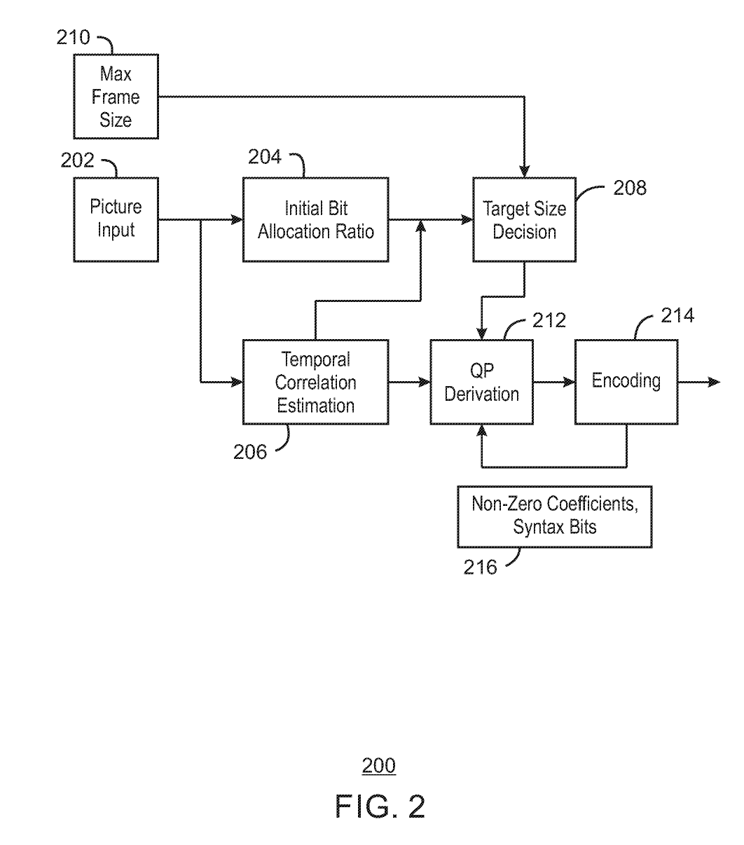

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

During video coding, bit rate control may be applied to each frame in order to create frames that meet the prescribed frame size of the encoding format of the target video stream. The various video compression formats use a stated bit rate for a video stream. The bit rate is the number of bits per second that are transmitted over a set period of time. Accordingly, the frames may be sized in such a manner that the number of bits per frame comports with the bit rate of the encoding format of the target video stream. A target bit rate oriented approach may waste bits when the video quality is of high quality. Put another way, in some cases more bits than necessary may be encoded for some frames. To avoid encoding more bits than necessary, a constant minimum quantization parameter (QP) may be used to cap a QP generated by the rate control module. In some cases, a size for each frame may be assigned based on the location within a group of pictures (GOP) for each respective frame and a target compression ratio. However, this pure compression ratio based strategy may cause quality fluctuations and lower overall quality for clips with periods of complex and/or simple scenes.

Embodiments described herein enable a target bit allocation for video coding. In embodiments, an adaptive hierarchical coding structure may assign a target frame size for each frame according to a temporal correlation within a GOP. With the same target bitrate, the frame size distribution is adapted according to the temporal correlation to achieve the best quality. To do so, the temporal similarity between the frames is estimated. By combining the target compression ratio and the estimated temporal similarity, the target size of each frame is then determined based on its location in the GOP. After encoding a previous frame, a quantization parameter estimation is then performed to derive the QP for the current frame to meet the target size. The present QP estimation method utilizes the temporal similarity information to successfully estimate the syntax bits for the next frame.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the inventions. The various appearances of “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a block diagram of an exemplary system that enables target bit allocation for video coding. The electronic device 100 may be, for example, a laptop computer, tablet computer, mobile phone, smart phone, or a wearable device, among others. The electronic device 100 may be used to receive and render media such as images and videos. The electronic device 100 may include a central processing unit (CPU) 102 that is configured to execute stored instructions, as well as a memory device 104 that stores instructions that are executable by the CPU 102. The CPU may be coupled to the memory device 104 by a bus 106. Additionally, the CPU 102 can be a single core processor, a multi-core processor, a computing cluster, or any number of other configurations. Furthermore, the electronic device 100 may include more than one CPU 102. The memory device 104 can include random access memory (RAM), read only memory (ROM), flash memory, or any other suitable memory systems. For example, the memory device 104 may include dynamic random access memory (DRAM).

The electronic device 100 also includes a graphics processing unit (GPU) 108. As shown, the CPU 102 can be coupled through the bus 106 to the GPU 108. The GPU 108 can be configured to perform any number of graphics operations within the electronic device 100. For example, the GPU 108 can be configured to render or manipulate graphics images, graphics frames, videos, streaming data, or the like, to be rendered or displayed to a user of the electronic device 100. In some embodiments, the GPU 108 includes a number of graphics engines, wherein each graphics engine is configured to perform specific graphics tasks, or to execute specific types of workloads.

The CPU 102 can be linked through the bus 106 to a display interface 110 configured to connect the electronic device 100 to one or more display devices 112. The display devices 112 can include a display screen that is a built-in component of the electronic device 100. In embodiments, the display interface 110 is coupled with the display devices 112 via any networking technology such as cellular hardware 124, WiFi hardware 126, or Bluetooth Interface 128 across the network 132. The display devices 112 can also include a computer monitor, television, or projector, among others, that is externally connected to the electronic device 100.

The CPU 102 can also be connected through the bus 106 to an input/output (I/O) device interface 114 configured to connect the electronic device 100 to one or more I/O devices 116. The I/O devices 116 can include, for example, a keyboard and a pointing device, wherein the pointing device can include a touchpad or a touchscreen, among others. The I/O devices 116 can be built-in components of the electronic device 100, or can be devices that are externally connected to the electronic device 100. Accordingly, in embodiments, the I/O device interface 114 is coupled with the I/O devices 116 via any networking technology such as cellular hardware 126, WiFi hardware 128, or a Bluetooth Interface 130 across the network 132. The I/O devices 116 can also include any I/O device that is externally connected to the electronic device 100.

A target bit allocation mechanism 118 may be used to determine a bit rate. Through target bit allocation, the frame size may be controlled to a predictable value. Controlling the frame size to this predictable value is important, especially for the network related applications. With an optimal bit allocation, various subjective and objective improvements can be obtained. A quantization parameter (QP) derivation mechanism 120 may be configured to derive a QP based on the target bit allocation from the target bit allocation mechanism 118.

Consider the High Efficiency Video Coding (HEVC) standard with a hierarchical coding structure. In the HEVC standard, rate control is used to assign the size of each frame based on each frame's location in a group of pictures (GOP) and a target compression ratio. The entire video sequence uses the same rate control assignment. As used herein, the sequence refers to the video data that is to be encoded. In some cases, video data is encoded in parallel fashion. The coding structure specifies frame types that may occur in a group of picture (GOP), such as intra-frames (I-frames) predicted without reference to another frame or frames. The frame type may also be an inter-predicted frames, such as predicted frames (P-frames) that are predicted with reference to another frame, and bi-directional predicted frames (B-frames) that are predicted with reference to multiple frames.

A pure compression ratio based coding strategy may cause quality fluctuations and lower overall quality for clips with period of complex and/or simple scenes. The target bit allocation mechanism 118 enables rate control based on temporal similarity or correlation. Further, the QP mechanism 120 may estimate the syntax bits for future encoding based on the statistics of current encoded frame.

The computing device 100 may also include a storage 124. The storage device 124 is a physical memory such as a hard drive, an optical drive, a flash drive, an array of drives, or any combinations thereof. The storage device 124 can store user data, such as audio files, video files, audio/video files, and picture files, among others. The storage device 124 can also store programming code such as device drivers, software applications, operating systems, and the like. The programming code stored to the storage device 124 may be executed by the CPU 102, GPU 108, or any other processors that may be included in the electronic device 100.

The CPU 102 may be linked through the bus 106 to cellular hardware 126. The cellular hardware 126 may be any cellular technology, for example, the 4G standard (International Mobile Telecommunications-Advanced (IMT-Advanced) Standard promulgated by the International Telecommunications Union—Radio communication Sector (ITU-R)). In this manner, the electronic device 100 may access any network 132 without being tethered or paired to another device, where the cellular hardware 126 enables access to the network 132.

The CPU 102 may also be linked through the bus 106 to WiFi hardware 128. The WiFi hardware 128 is hardware according to WiFi standards (standards promulgated as Institute of Electrical and Electronics Engineers' (IEEE) 802.11 standards). The WiFi hardware 128 enables the electronic device 100 to connect to the Internet using the Transmission Control Protocol and the Internet Protocol (TCP/IP). Accordingly, the electronic device 100 can enable end-to-end connectivity with the Internet by addressing, routing, transmitting, and receiving data according to the TCP/IP protocol without the use of another device. Additionally, a Bluetooth Interface 130 may be coupled to the CPU 102 through the bus 106. The Bluetooth Interface 130 is an interface according to Bluetooth networks (based on the Bluetooth standard promulgated by the Bluetooth Special Interest Group). The Bluetooth Interface 130 enables the electronic device 100 to be paired with other Bluetooth enabled devices through a personal area network (PAN). Accordingly, the network 132 may be a PAN. Examples of Bluetooth enabled devices include a laptop computer, desktop computer, ultrabook, tablet computer, mobile device, or server, among others.

The block diagram of FIG. 1 is not intended to indicate that the electronic device 100 is to include all of the components shown in FIG. 1. Rather, the computing system 100 can include fewer or additional components not illustrated in FIG. 1 (e.g., sensors, power management integrated circuits, additional network interfaces, etc.). The electronic device 100 may include any number of additional components not shown in FIG. 1, depending on the details of the specific implementation. Furthermore, any of the functionalities of the CPU 102 may be partially, or entirely, implemented in hardware and/or in a processor. For example, the functionality may be implemented with an application specific integrated circuit, in logic implemented in a processor, in logic implemented in a specialized graphics processing unit, or in any other device.

In embodiments, an adaptive hierarchical (non-uniform bits) coding structure assigns a target frame size according to the temporal correlation within a GOP for each frame. As used herein, the target frame size refers to the number of generated bits used to represent each frame. According to the present techniques, with the same target bitrate, the frame size distribution is adapted according to the temporal similarity or correlation to achieve a best quality. To do so, the temporal similarity between the frames is estimated. With a target compression ratio and the estimated temporal similarity, the target size of each frame is then determined based on its location in the GOP. After encoding a previous frame, a quantization parameter is estimated to derive the QP for the current frame to meet the target frame size. In embodiments, QP estimation as described herein utilizes the temporal similarity information to estimate syntax bits associated with encoding.

FIG. 2 is a block diagram of target bit allocation according to the present techniques. At block 202, a picture input is obtained. At block 204, an initial bit allocation ratio is determined. The coding structures are first determined by the application processing the video stream, such as a low delay (encoding process follows a display order) coding structure or a random access (encoding process does not follow the display order and bidirectional prediction can be used to predict from a future frame) coding structure. Further, the application processing the video stream also determines and how many frames are included in a GOP. The initial bit allocation ratio is then decided for each frame within a GOP.

At block 206, temporal correlation estimation is performed. Temporal correlation estimation includes determining the similarity between frames of a GOP. In embodiments, the temporal correlation among the frames is estimated. Based on the temporal correlation, the initial bit allocation ratio is adjusted and the target frame size for each frame is decided based on the budget of the current GOP. Thus, at block 208, a target size decision is made using as inputs a max frame size from block 210, the initial bit allocation ratio from block 204, and the temporal correlation estimation found at block 206. In embodiments, the max frame size at block 210 is based on the particular encoding standard being used to encode the video stream. Various video standards may be used according to the present techniques. Exemplary standards include the H.264/MPEG-4 Advanced Video Coding (AVC) standard developed by the ITU-T Video Coding Experts Group (VCEG) with the ISO/IEC JTC1 Moving Picture Experts Group (MPEG), first completed in May 2003 with several revisions and extensions added to date. Another exemplary standard is the High Efficiency Video Coding (HEVC) standard developed by the same organizations with the second version completed and approved in 2014 and published in early 2015. A third exemplary standard is the VP9 standard, initially released on Dec. 13, 2012 by Google.

At block 212, a QP is estimated. The QP as determined and/or modified in accordance with embodiments herein may be used to quantize transform coefficients associated with a chunk of video data. The quantized transform coefficients and quantization parameters may be encoded into a bitstream for use at a decoder. The decoder may decompress and/or decode the bitstream to reproduce frames for presentation/display to an end user. In embodiments, the QP is derived by analyzing the temporal correlation and the previous encoded frame information including the number of non-zero coefficients and syntax bits.

Accordingly, at block 214 encoding is performed using the derived QP and the target bit allocation for each frame. At block 216, non-zero coefficients and syntax bits are provided to block 212 for future QP derivation. Compared to an HEVC Test Model (HM) provided reference bit allocation, the present techniques adaptively allocate different target frame sizes to different video clips, even with the same compression ratio. Further, the QP estimation as described herein successfully achieves the assigned target frame size. The HEVC standard is described herein for descriptive purposes. However, the present techniques can be used with any encoding standard, including but not limited to the H.264/MPEG-4 Advanced Video Coding (AVC) standard, the High Efficiency Video Coding (HEVC) standard, and the like.

In embodiments, the initial bit allocation ratio decision is based on the bit allocation ratio difference increasing within a GOP with a higher compression ratio. The compression ratio is calculated in bits per second (bps). Unlike the HM reference rate control, in the present techniques the bit allocation ratio difference is reduced to zero or near zero when compression ratio is less than a threshold. This results in all frames of a GOP having a same target size with extremely high bitrate coding when the bits per second are greater than the threshold, unless the frame is an intra-predicted or scene change frame. The low delay coding structure and the random-access coding structure each have different initial bit allocation ratios when the bits per second (bps) target is the same. The initial bit allocation ratio can be obtained by either a predefined checkup table or calculation on the fly.

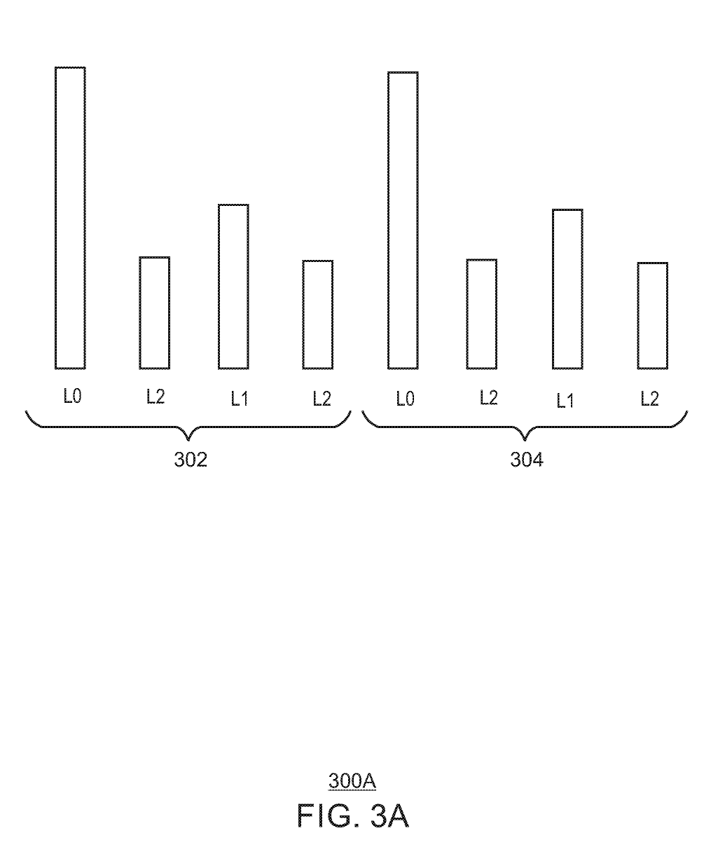

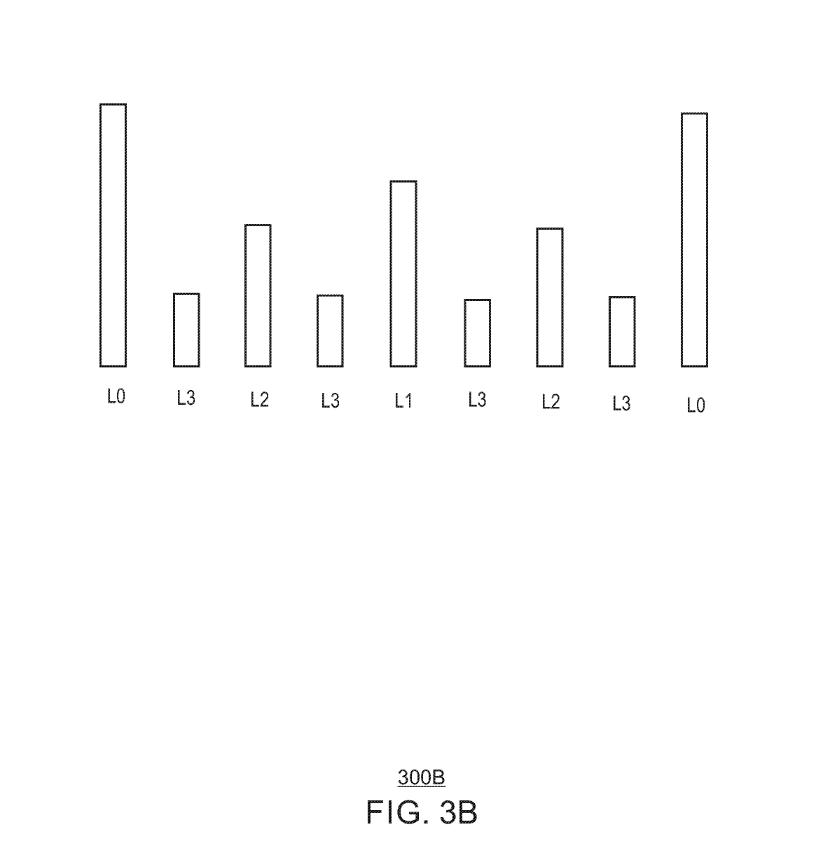

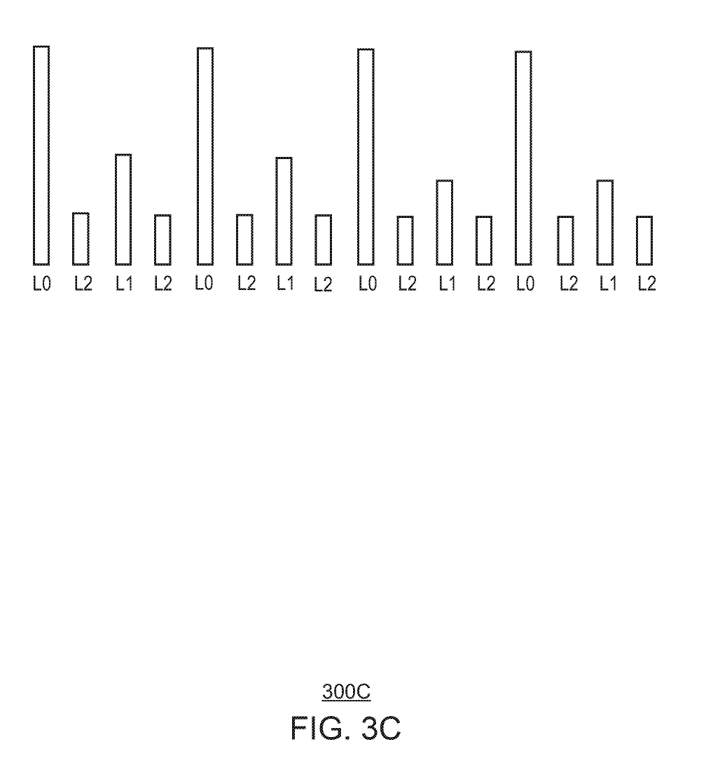

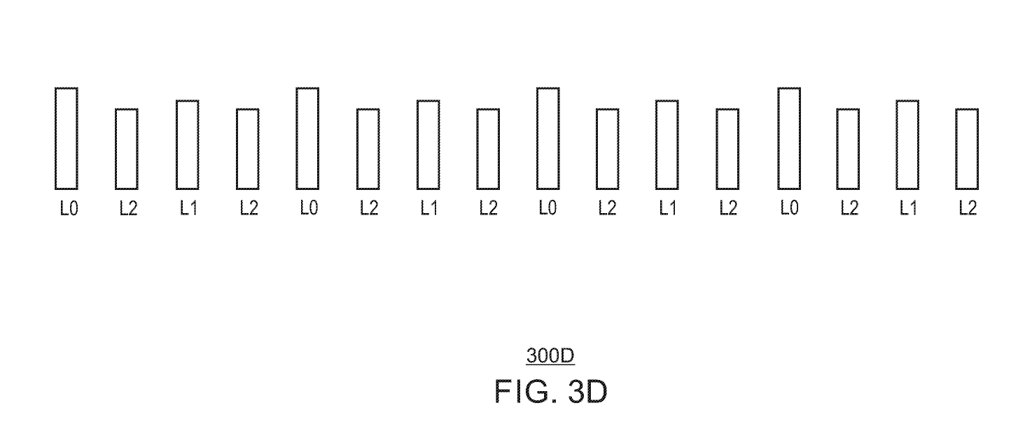

FIG. 3A is an illustration of a typical encoding structure 300A when the GOP size equals four. A GOP is made up of a series of pictures or frames with an adaptive hierarchical coding structure. Usually, the first frame is coded with a high quality such that the subsequent frames can benefit from using it as the reference frame. For example, the intra-frame is the reference frame on which the first frame of the GOP is based. The intra frame (I-frame) requires the largest amount of data because it cannot predict from other frames and all of the detail for the sequence is based on the foundation that it represents. The next frame in the GOP may be a predicted frame (P-frame) or a bidirectional predicted frame (B-frame). The names may be shortened to I-frame, P-frame and B-frame or I, P, and B, respectively. The P-frame has less data content than the I-frame, and some of the changes between the two frames is predicted based on certain references in the frames. Except for the first GOP or a GOP with random access point, the other, subsequent GOPs consist of P-frames and/or B-frames.

In FIG. 3A, L0, L1, and L2 may represent any frame type. The different height of the bars indicates that the encoding intentionally uses more bits for high quality frames (represented by bars of greater height) and uses fewer bits for low quality frames (represented by bars of lower height). The higher quality frames use a smaller QP, while the lower quality frames have a higher QP. In FIG. 3A, two GOPs 302 and 304 are illustrated. Frame L0 in each of GOP 302 and GOP 304 uses the most bits for encoding, while frame L2 uses the least bits for encoding. The frame L1 uses less bits than the frame L0, but more bits that the frame L2.

The initial bit allocation can be achieved by choosing value from a set of predefined look-up tables. The predefined table can be represented as:

$$Initial\_ratio [ ] = \{ \{ L 0 bps 1 , L 2 bps 1 , L 1 bps 1 , L2 bps 1 \} , \\ \{ L 0 bps 2 , L 2 bps 2 , L 1 bps 2 , L2 bps 2 \} , \\ \{ L 0 bps 3 , L 2 bps 3 , L 1 bps 3 , L2 bps 3 \} , … \{ 1 , 1 , 1 , 1 \} \}$$

with compression ratio bps1<bps2<bps3 and so on. Thus, for each subsequent GOP, the compression ratio increases.

After the initial bit allocation ratio is determined, it is adjusted based on the temporal correlation estimation result. If the temporal correlation estimation shows the video sequence has a strong temporal correlation, such as a very static video conference clip, the initial ratio is adjusted such that the compression ratio is increased for a high-quality level picture such as L0 and compression ratio is decreased for low quality level picture such as L2. On the other hand, if the temporal correlation estimation shows the video sequence has a very weak temporal correlation, such as video clips with random motion or several scene changes, the initial ratio is adjusted such that the compression ratio is decreased for a high-quality level picture such as L0 and ratio is increased for a low-quality level picture such as L2. In one example embodiment for a GOP of size four, as above with bps1, the final ratio can be calculated by the following equations:

Final_L0bps1=L0bps1*T_factor0/W

Final_L1bps1=L1bps1*T_factor1/W

Final_L2bps1=L2bps1*T_factor2/W

W=L0bps1*T_factor0+L1bps1*T_factor1+2*L2bps1*T_factor2

where T_factor1 is in the range of 1˜T_factor0, T_factor2 is in the range of 1˜T_factor1. Additionally, T_factor0 is greater than 0 for higher temporal correlation and T_factor0 is less than 1 for lower temporal correlation. Each T_factor represents adjustment factors based on the temporal correlation within the GOP.

Assuming each GOP has a budget size of GOP_Size, the target size for frame L0 is:

Target_L0=Final_L0bps1*GOP_Size

the target size for frame L1 is

Target_L1=Final_L1bps1*GOP_Size

and the target size for frame L2 is

Target_L2=Final_L2bps1*GOP_Size

After the target size for each frame is found, the target size of the higher quality level frame target size should be greater or equal to the lower quality level frame target size. For example, if Target_L1<Target_L2, Target_L1=Target_L2. If Target_L0<Target_L1, Target_L0=Target_L1.

FIG. 3B is an illustration of a typical encoding structure 300B when the GOP size equals eight. If GOP size 8 is used as illustrated as following, similar strategy can be used and the final target size should satisfy Target_L0>=Target_L1>=Target_L2>=Target_L3.

By using the proposed strategy, a typical frame size distribution for clips with static or minor motions (and therefore strong temporal correlations) can be illustrated as shown in FIG. 3C if a GOP size four is used. As illustrated, the size differences among frames can be huge.

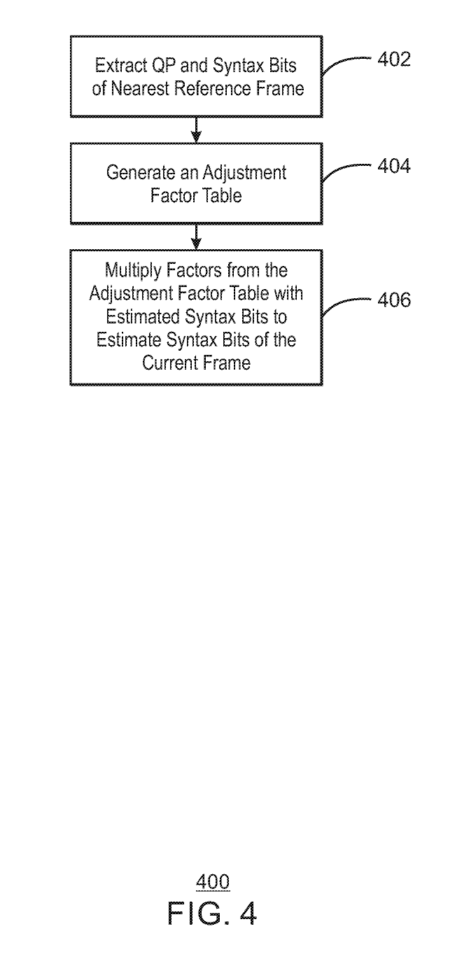

FIG. 3D is an illustration of a typical encoding structure 300D when the GOP size equals four. In the example of FIG. 4, a typical frame size distribution for clips with heavy or random motions (weak temporal correlations) is illustrated with a GOP of size four. In such an example, the size differences among frames are very small.

Any method to measure the temporal correlation can be used according to the present techniques. For example, a fast motion search on down sampled video can be used to obtain an average prediction distortion and number of small motion vectors. They are combined to generate a temporal correlation factor and this factor is used to compare with predefined thresholds for temporal correlation. If look ahead preprocessing is available, the temporal correlation estimation can be applied on the future frames. Otherwise, the estimation is based on an average of the temporal correlation for past encoded frames in last several GOP.

FIG. 4 is a process flow diagram of quantization parameter (QP) derivation. With the given target frame size, a QP is derived to achieve the target frame size. For each frame, the compressed bitstream includes the bits generated by transform coefficients which associated with the QP and the bits associated with syntax. Syntax bits are those bits used to describe the non-transform coefficients related video data, including the prediction modes applied to the video data. A decoder uses the syntax bits to reconstruct a received encoded video stream. Syntax bits include, but are not limited to, bits that indicate encoding mode, block partition motion vector, and the like.

At block 402, the QP and syntax bits of the nearest reference frame that is used by the current frame for encoding are extracted. Frames that use other frames for encoding may be, for example, a P-frame or a B-frame. At block 404, an adjustment factor table is generated by using the estimated temporal correlation, the QP and syntax bits of the reference frame. The adjustment factor table includes values that are used to weight the syntax bits. The typical table has a size of eleven for eleven entries, such as A_factor[QP_previous−5] . . . QP_previous+5] with A_factor[QP_previous−5]>=A_factor[QP_previous−4] . . . >=A_factor[QP_previous+4]>=A_factor[QP_previous+5], where A_factor[QP_previous]=1. The A_factor indicates an adjustment factor applied to the estimated syntax bits of the current frame. Additionally, “QP_previous” indicates the QP of the previous frame. The QP may be adjusted by +/−X. For example, if the current frame's QP is denoted as Q_current=QP_previous−1, the estimated current frame syntax bits are equal to A_factor[QP_previous−1]*SyntaxBits(reference). Generally, the adjustment factor is a value in the range of zero to three. For example, for frames with strong temporal correlation, a A_factor[QP_previous+5] can be reduced to 0.2 and A_factor[QP_previous−5] can be increased to 3. For frames with very weak temporal correlation, the range is smaller and A_factor[QP_previous+5] can be reduced to 0.9 and A_factor[QP_previous−5] can be increased to 1.1.

At block 406, the above factors from the adjustment factor table are multiplied with the syntax bits obtained in at block 402 to estimate the syntax bits of the current frame that corresponds to different QP. By combining with the estimated bits of transform coefficients, the final QP can be derived by searching the QP which can achieve the closest size to the target size.

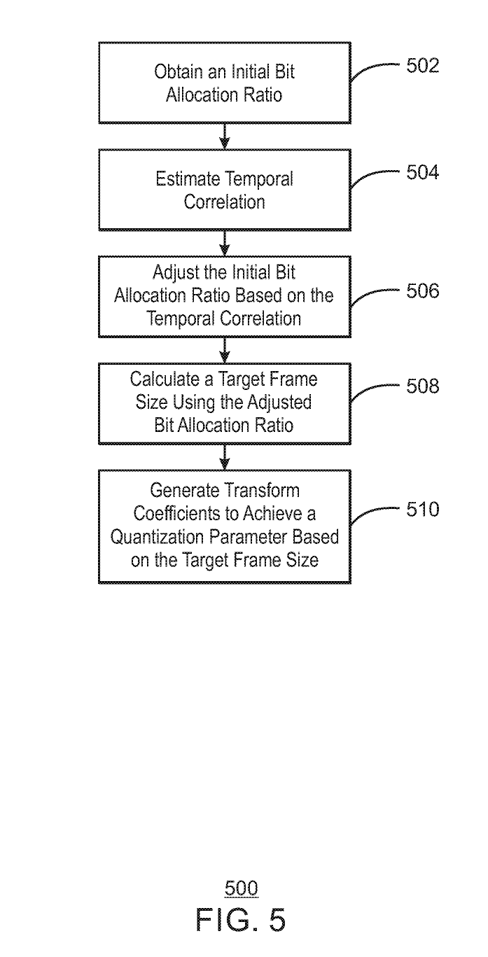

FIG. 5 is a process flow diagram of a method 500 for target bit allocation for video coding. At block 502, an initial bit allocation ratio is obtained. At block 504, the temporal correlation is estimated. At block 506, the initial bit allocation ratio is adjusted based on the temporal correlation. At block 508, a target frame size is calculated using the adjusted bit allocation ratio. At block 510, transform coefficients are generated to achieve a quantization parameter based on the target frame size.

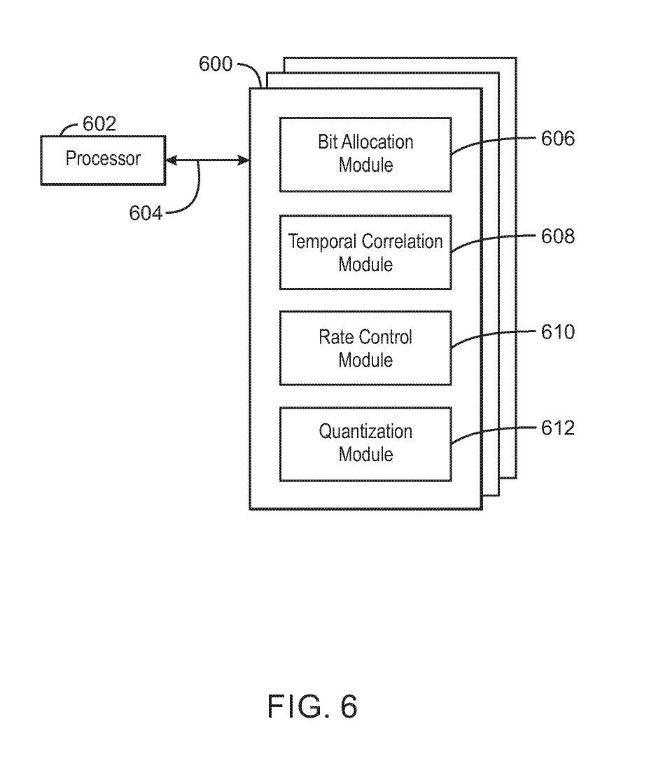

FIG. 6 is a block diagram showing a tangible, non-transitory computer-readable medium 600 that stores code for target bit allocation, in accordance with embodiments. The tangible, non-transitory computer-readable medium 600 may be accessed by a processor 602 over a computer bus 604. Furthermore, the tangible, non-transitory computer-readable medium 600 may include code configured to direct the processor 602 to perform the methods described herein.

The various software components discussed herein may be stored on the tangible, non-transitory computer-readable medium 600, as indicated in FIG. 6. For example, a bit allocation module 606 may be configured to obtain an initial bit allocation ratio. A temporal correlation module 608 may be configured to determine a temporal correlation of a frame, and adjust the initial bit allocation ratio based on the temporal correlation. A rate control module 610 may be configured to determine a target frame size based on the adjusted bit allocation ratio and the temporal correlation. Further, a quantization module 612 may be configured to generate transform coefficients to achieve a quantization parameter based on a target frame size.

The block diagram of FIG. 6 is not intended to indicate that the tangible, non-transitory computer-readable medium 600 is to include all of the components shown in FIG. 6. Further, the tangible, non-transitory computer-readable medium 600 may include any number of additional components not shown in FIG. 6, depending on the details of the specific implementation.

Example 1 is an apparatus for video encoding with a target bit allocation. The apparatus includes a rate control module to obtain an initial bit allocation ratio and to adjust an initial bit allocation ratio based on a temporal correlation; a temporal correlation module to estimate the temporal correlation of each frame; a target size decision module to calculate a target frame size based on the adjusted bit allocation ratio and the temporal correlation; a quantization module to generate transform coefficients to achieve a quantization parameter based on the target frame size.

Example 2 includes the apparatus of example 1, including or excluding optional features. In this example, a target bit rate is used to adapt a frame size distribution within a group of pictures (GOP) by applying a plurality of frame sizes to the group of pictures based on a GOP budget.

Example 3 includes the apparatus of any one of examples 1 to 2, including or excluding optional features. In this example, generating transform coefficients to achieve the quantization parameter is to estimate syntax bits for a next frame, wherein the syntax bits describe all non-transform coefficients related bits contained in a video stream.

Example 4 includes the apparatus of any one of examples 1 to 3, including or excluding optional features. In this example, the temporal correlation between a prior frame and current frame is used to estimate syntax bits for a current frame.

Example 5 includes the apparatus of any one of examples 1 to 4, including or excluding optional features. In this example, the temporal correlation is used to generate an adjustment factor table that comprises values used to determine quantization parameters.

Example 6 includes the apparatus of any one of examples 1 to 5, including or excluding optional features. In this example, the apparatus includes generating an adaptive hierarchical coding structure for a video stream.

Example 7 includes the apparatus of any one of examples 1 to 6, including or excluding optional features. In this example, an initial bit allocation ratio is determined by a target compression ratio and encoding structure.

Example 8 includes the apparatus of any one of examples 1 to 7, including or excluding optional features. In this example, the initial bit allocation ratio is obtained by a predefined checkup table or a calculation on the fly.

Example 9 includes the apparatus of any one of examples 1 to 8, including or excluding optional features. In this example, the target frame size is based on a calculated bit allocation ratio and previously encoded bits.

Example 10 includes the apparatus of any one of examples 1 to 9, including or excluding optional features. In this example, the apparatus includes encoding video data using the derived quantization parameter and the target bit allocation for each frame.

Example 11 is a method for video encoding with a target bit allocation. The method includes obtaining an initial bit allocation ratio for a current frame; estimating a temporal correlation of the current frame; adjusting the initial bit allocation ratio based on the temporal correlation; calculating a target frame size based on the adjusted bit allocation ratio and the temporal correlation; and generating transform coefficients to achieve a quantization parameter based on the target frame size.

Example 12 includes the method of example 11, including or excluding optional features. In this example, the temporal correlation is estimated by measuring a difference between the current frame and a plurality of previously encoded frames.

Example 13 includes the method of any one of examples 11 to 12, including or excluding optional features. In this example, the temporal correlation is estimated by measuring a difference between the current frame and a plurality of future frames in response to a buffering delay.

Example 14 includes the method of any one of examples 11 to 13, including or excluding optional features. In this example, a target bit rate is used to adapt a frame size distribution within a group of pictures.

Example 15 includes the method of any one of examples 11 to 14, including or excluding optional features. In this example, generating transform coefficients to achieve the quantization parameter is to estimate syntax bits for a next frame.

Example 16 includes the method of any one of examples 11 to 15, including or excluding optional features. In this example, temporal similarity information of a prior frame is used to estimate syntax bits for the current frame.

Example 17 includes the method of any one of examples 11 to 16, including or excluding optional features. In this example, each frame in a sequence of frames has a different target bit allocation.

Example 18 includes the method of any one of examples 11 to 17, including or excluding optional features. In this example, the method includes generating an adaptive hierarchical coding structure for a video stream.

Example 19 includes the method of any one of examples 11 to 18, including or excluding optional features. In this example, an initial bit allocation ratio is determined by a target compression ratio and encoding structure.

Example 20 includes the method of any one of examples 11 to 19, including or excluding optional features. In this example, the initial bit allocation ratio is obtained by a predefined checkup table or a calculation on the fly.

Example 21 includes the method of any one of examples 11 to 20, including or excluding optional features. In this example, the target frame size is based on a calculated bit allocation ratio and previously encoded bits.

Example 22 includes the method of any one of examples 11 to 21, including or excluding optional features. In this example, the method includes encoding video data using the derived quantization parameter and the target bit allocation for each frame.

Example 23 is a system for video encoding with a target bit allocation. The system includes a memory that is to store instructions; and a processor communicatively coupled to the memory, wherein when the processor is to execute the instructions, the processor is to: obtain an initial bit allocation ratio; estimate a temporal correlation; adjust the initial bit allocation ratio based on the temporal correlation; calculate a target frame size based on the adjusted bit allocation ratio and the temporal correlation; and generate transform coefficients to achieve a quantization parameter based on the target frame size.

Example 24 includes the system of example 23, including or excluding optional features. In this example, the temporal correlation is estimated by measuring a difference between a current frame and a plurality of previously encoded frames.

Example 25 includes the system of any one of examples 23 to 24, including or excluding optional features. In this example, the temporal correlation is estimated by measuring a difference between a current frame and a plurality of future frames in response to a buffering delay.

Example 26 includes the system of any one of examples 23 to 25, including or excluding optional features. In this example, a target bit rate is used to adapt a frame size distribution within a group of pictures.

Example 27 includes the system of any one of examples 23 to 26, including or excluding optional features. In this example, generating transform coefficients to achieve the quantization parameter is to estimate syntax bits for a next frame.

Example 28 includes the system of any one of examples 23 to 27, including or excluding optional features. In this example, temporal similarity information of a prior frame is used to estimate syntax bits for a current frame.

Example 29 includes the system of any one of examples 23 to 28, including or excluding optional features. In this example, each frame in a sequence of frames has a different target bit allocation.

Example 30 includes the system of any one of examples 23 to 29, including or excluding optional features. In this example, the system includes generating an adaptive hierarchical coding structure for a video stream.

Example 31 includes the system of any one of examples 23 to 30, including or excluding optional features. In this example, an initial bit allocation ratio is determined by a target compression ratio and encoding structure.

Example 32 includes the system of any one of examples 23 to 31, including or excluding optional features. In this example, the initial bit allocation ratio is obtained by a predefined checkup table or a calculation on the fly.

Example 33 includes the system of any one of examples 23 to 32, including or excluding optional features. In this example, the target frame size is based on a calculated bit allocation ratio and previously encoded bits.

Example 34 includes the system of any one of examples 23 to 33, including or excluding optional features. In this example, the system includes encoding video data using the derived quantization parameter and the target bit allocation for each frame.

Example 35 is a tangible, non-transitory, computer-readable medium. The computer-readable medium includes instructions that direct the processor to obtain an initial bit allocation ratio; estimate a temporal correlation; adjust the initial bit allocation ratio based on the temporal correlation; calculate a target frame size based on the adjusted bit allocation ratio and the temporal correlation; and generate transform coefficients to achieve a quantization parameter based on the target frame size.

Example 36 includes the computer-readable medium of example 35, including or excluding optional features. In this example, the temporal correlation is estimated by measuring a difference between a current frame and a plurality of previously encoded frames.

Example 37 includes the computer-readable medium of any one of examples 35 to 36, including or excluding optional features. In this example, the temporal correlation is estimated by measuring a difference between a current frame and a plurality of future frames in response to a buffering delay.

Example 38 includes the computer-readable medium of any one of examples 35 to 37, including or excluding optional features. In this example, a target bit rate is used to adapt a frame size distribution within a group of pictures.

Example 39 includes the computer-readable medium of any one of examples 35 to 38, including or excluding optional features. In this example, generating transform coefficients to achieve the quantization parameter is to estimate syntax bits for a next frame.

Example 40 includes the computer-readable medium of any one of examples 35 to 39, including or excluding optional features. In this example, temporal similarity information of a prior frame is used to estimate syntax bits for a current frame.

Example 41 includes the computer-readable medium of any one of examples 35 to 40, including or excluding optional features. In this example, each frame in a sequence of frames has a different target bit allocation.

Example 42 includes the computer-readable medium of any one of examples 35 to 41, including or excluding optional features. In this example, the computer-readable medium includes generating an adaptive hierarchical coding structure for a video stream.

Example 43 includes the computer-readable medium of any one of examples 35 to 42, including or excluding optional features. In this example, an initial bit allocation ratio is determined by a target compression ratio and encoding structure.

Example 44 includes the computer-readable medium of any one of examples 35 to 43, including or excluding optional features. In this example, the initial bit allocation ratio is obtained by a predefined checkup table or a calculation on the fly.

Example 45 includes the computer-readable medium of any one of examples 35 to 44, including or excluding optional features. In this example, the target frame size is based on a calculated bit allocation ratio and previously encoded bits.

Example 46 includes the computer-readable medium of any one of examples 35 to 45, including or excluding optional features. In this example, the computer-readable medium includes encoding video data using the derived quantization parameter and the target bit allocation for each frame.

Example 47 is an apparatus for video encoding with a target bit allocation. The apparatus includes instructions that direct the processor to a rate control module to obtain an initial bit allocation ratio; a means to adjust an initial bit allocation ratio based on a temporal correlation; a means to estimate the temporal correlation of each frame; a means to calculate a target frame size based on the adjusted bit allocation ratio and the temporal correlation; a quantization module to generate transform coefficients to achieve a quantization parameter based on the target frame size.

Example 48 includes the apparatus of example 47, including or excluding optional features. In this example, a target bit rate is used to adapt a frame size distribution within a group of pictures by applying a plurality of frame sizes to the group of pictures based on a GOP budget.

Example 49 includes the apparatus of any one of examples 47 to 48, including or excluding optional features. In this example, generating transform coefficients to achieve the quantization parameter is to estimate syntax bits for a next frame, wherein the syntax bits describe all non-transform coefficients related bits contained in a video stream.

Example 50 includes the apparatus of any one of examples 47 to 49, including or excluding optional features. In this example, the temporal correlation between a prior frame and current frame is used to estimate syntax bits for a current frame.

Example 51 includes the apparatus of any one of examples 47 to 50, including or excluding optional features. In this example, the temporal correlation is used to generate an adjustment factor table that comprises values used to determine quantization parameters.

Example 52 includes the apparatus of any one of examples 47 to 51, including or excluding optional features. In this example, the apparatus includes generating an adaptive hierarchical coding structure for a video stream.

Example 53 includes the apparatus of any one of examples 47 to 52, including or excluding optional features. In this example, an initial bit allocation ratio is determined by a target compression ratio and encoding structure.

Example 54 includes the apparatus of any one of examples 47 to 53, including or excluding optional features. In this example, the initial bit allocation ratio is obtained by a predefined checkup table or a calculation on the fly.

Example 55 includes the apparatus of any one of examples 47 to 54, including or excluding optional features. In this example, the target frame size is based on a calculated bit allocation ratio and previously encoded bits.

Example 56 includes the apparatus of any one of examples 47 to 55, including or excluding optional features. In this example, the apparatus includes encoding video data using the derived quantization parameter and the target bit allocation for each frame.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. An apparatus for video encoding with a target bit allocation, comprising:
a rate control module to obtain an initial bit allocation ratio and to adjust an initial bit allocation ratio based on a temporal correlation;
a temporal correlation module to estimate the temporal correlation of each frame;
a target size decision module to calculate a target frame size based on the adjusted bit allocation ratio and the temporal correlation;
a quantization module to generate transform coefficients to achieve a quantization parameter based on the target frame size.

2. The apparatus of claim 1, wherein a target bit rate is used to adapt a frame size distribution within a group of pictures (GOP) by applying a plurality of frame sizes to the group of pictures based on a GOP budget.

3. The apparatus of claim 1, wherein generating transform coefficients to achieve the quantization parameter is to estimate syntax bits for a next frame, wherein the syntax bits describe all non-transform coefficients related bits contained in a video stream.

4. The apparatus of claim 1, wherein the temporal correlation between a prior frame and current frame is used to estimate syntax bits for a current frame.

5. The apparatus of claim 1, wherein the temporal correlation is used to generate an adjustment factor table that comprises values used to determine quantization parameters.

6. The apparatus of claim 1, comprising generating an adaptive hierarchical coding structure for a video stream.

7. The apparatus of claim 1, wherein an initial bit allocation ratio is determined by a target compression ratio and encoding structure.

8. The apparatus of claim 1, wherein the initial bit allocation ratio is obtained by a predefined checkup table or a calculation on the fly.

9. The apparatus of claim 1, wherein the target frame size is based on a calculated bit allocation ratio and previously encoded bits.

10. The apparatus of claim 1, comprising encoding video data using the derived quantization parameter and the target bit allocation for each frame.

11. A method for video encoding with a target bit allocation, comprising:
obtaining an initial bit allocation ratio for a current frame;
estimating a temporal correlation of the current frame;
adjusting the initial bit allocation ratio based on the temporal correlation;
calculating a target frame size based on the adjusted bit allocation ratio and the temporal correlation; and
generating transform coefficients to achieve a quantization parameter based on the target frame size.

12. The method of claim 11, wherein the temporal correlation is estimated by measuring a difference between the current frame and a plurality of previously encoded frames.

13. The method of claim 11, wherein the temporal correlation is estimated by measuring a difference between the current frame and a plurality of future frames in response to a buffering delay.

14. The method of claim 11, wherein a target bit rate is used to adapt a frame size distribution within a group of pictures.

15. The method of claim 11, wherein generating transform coefficients to achieve the quantization parameter is to estimate syntax bits for a next frame.

16. A system for video encoding with a target bit allocation, comprising:
a memory that is to store instructions; and
a processor communicatively coupled to the memory, wherein when the processor is to execute the instructions, the processor is to:
obtain an initial bit allocation ratio;
estimate a temporal correlation;
adjust the initial bit allocation ratio based on the temporal correlation;
calculate a target frame size based on the adjusted bit allocation ratio and the temporal correlation; and
generate transform coefficients to achieve a quantization parameter based on the target frame size.

17. The system of claim 16, wherein temporal similarity information of a prior frame is used to estimate syntax bits for a current frame.

18. The system of claim 16, wherein each frame in a sequence of frames has a different target bit allocation.

19. The system of claim 16, comprising generating an adaptive hierarchical coding structure for a video stream.

20. The system of claim 16, wherein an initial bit allocation ratio is determined by a target compression ratio and encoding structure.

21. A tangible, non-transitory, computer-readable medium comprising instructions that, when executed by a processor, direct the processor to:
obtain an initial bit allocation ratio;
estimate a temporal correlation;
adjust the initial bit allocation ratio based on the temporal correlation;
calculate a target frame size based on the adjusted bit allocation ratio and the temporal correlation; and
generate transform coefficients to achieve a quantization parameter based on the target frame size.

22. The computer-readable medium of claim 21, wherein an initial bit allocation ratio is determined by a target compression ratio and encoding structure.

23. The computer-readable medium of claim 21, wherein the initial bit allocation ratio is obtained by a predefined checkup table or a calculation on the fly.

24. The computer-readable medium of claim 21, wherein the target frame size is based on a calculated bit allocation ratio and previously encoded bits.

25. The computer-readable medium of claim 21, comprising encoding video data using the derived quantization parameter and the target bit allocation for each frame.
